(19) United States
(12) Patent Application Publication
(10) Pub. No.: US 2026/0266049 A1
(43) Pub. Date: Sep. 10, 2026

(54) SYSTEM AND METHOD FOR THE SPACED-APART FASTENING OF CURTAIN WALLING PANELS

(71) Applicant: EJOT SE & CO. KG, Bad Berleburg (DE)

(72) Inventors: Kostja HEINRICH, Bad Berleburg (DE); Michael PITZ, Battenberg (DE)

(21) Appl. No.: 18/876,749

(22) PCT Filed: Jun. 22, 2023
(86) PCT No.: PCT/EP2023/066958

§ 371 Date: Dec. 19, 2024

(30) Foreign Application Priority Data
Jun. 22, 2022 (DE) 10 2022 206 213.2

(51) Int. Cl. E04B 2/88; F16B 5/02; F16B 5/04; F16B 19/10; F16B 25/10; F16B 35/04

(52) U.S. Cl. CPC E04B 2/88; F16B 5/02; F16B 5/04; F16B 19/1081; F16B 25/103; F16B 35/044

(57) ABSTRACT

A system for installing curtain walling panels is provided. The system comprises a sleeve and a fastening element. The sleeve has a top part and a bottom part and the fastening element has a head and a shaft. The bottom part of the sleeve comprises at least two holding elements which extend at least partially outwards, wherein the holding elements are connected to one another via lateral connections, as a result of which an opening is formed between the holding elements and the lateral connections, in which opening the shaft of the fastening element is arranged during installation. The shaft of the fastening element comprises a projection which forces the holding elements outwards when the fastening element is inserted into a substrate during installation. Furthermore, a method for installing curtain walling panels is provided, which method can use the described system.

The present invention relates to a system and a method for spaced-apart fastening of curtain walling panels to a substrate.

Curtain walling panels, which may also generally be referred to as facade panels, cladding panels, or facing tiles, are fastened to a substrate, usually a wall, by means of fastening elements, for example screws. In order for the curtain walling panels to be able to be mounted accurately and without damaging the curtain walling panels and for the curtain walling panels nevertheless to be able to move to a certain extent relative to the fastening points-for example on account of thermal changes—centering means have been developed, such as are described, for example, in WO 2017/125166A1 .

However, there is still a need to simplify the installation of the curtain walling panels and to improve the quality of the installation. For example, the use of intermediate layers, which are frequently used between the curtain walling panel and the substrate, is cumbersome in some cases, with the result that it would be desirable to abstain from using such an intermediate layer. In other cases, a relative movement between the curtain walling panel and the fastening element fastened in the substrate is not desired.

This object of improving the installation of curtain walling panels is achieved by the invention defined in the independent claims. Preferred embodiments emerge from the dependent claims and from the following detailed description.

The object is achieved by a system for installing curtain walling panels which has a sleeve and a fastening element.

The sleeve has a top part and a bottom part. The top part and the bottom part can be connected to one another and define a volume in which the fastening element is arranged during installation. The volume can be, for example, a substantially cylindrical volume, wherein the top part and the bottom part form sections of a hollow cylinder. The sections of the hollow cylinder can have one or more cutouts in their lateral surface.

In the present invention, the bottom part of the sleeve has at least two holding elements which extend at least partially outwards. The holding elements can extend outwards relative to the volume formed by the bottom part and the top part of the sleeve. Thereby, the holding elements can be adapted to hold a curtain walling panel relative to a substrate in the mounted state. This can be achieved in that the curtain walling panel rests on the outwardly extending holding elements. Preferably, the at least two holding means are located at opposite positions of the bottom part, wherein the positions are opposite each other in a direction which runs perpendicular to the mounting direction. In the case of a cylindrical sleeve, this can be a radial direction. If the bottom part has more than two holding elements, the holding elements are preferably arranged in a radial extending plane. Further preferably, the holding elements have equidistant distances to their direct neighbors. In the case of three holding elements, the three holding elements lie, for example, preferably in the radial plane by an angle of 120° apart or in the case of four holding elements by 90°.

The holding elements can have a height. If the holding elements are arranged between the curtain walling panel and the substrate during installation and adjoin both the substrate and the curtain walling panel, then the height of the holding elements corresponds to the distance of the curtain walling panel from the substrate. The distance of the spaced-apart installation can thus be influenced by the selection of the height of the holding elements.

The at least two holding elements are connected to one another via lateral connections. The lateral connections are connecting elements which connect two holding elements to one another, i.e. the connection may substantially extend in a direction from one holding element to an opposite and/or adjacent holding element. In this case, the lateral connections can extend in a direction which extends perpendicular to the installation direction, similarly to the holding elements. It can also be stated that the lateral connections are substantially transverse to an axis which is defined by a direction of extent of the fastening element. The lateral connections preferably form connections which are also present after the installation. An opening in which the shaft of the fastening element is arranged during the installation is formed by the at least two holding elements and the lateral connections which connect them.

In the present invention, the fastening element has a head and a shaft, and preferably a drilling tip. The head and the drilling tip are typically arranged at opposite ends of the shaft. In some embodiments, the fastening element may have a self-tapping design. In this case, the fastening element does not necessarily have to have a drilling tip, but may be adapted to be inserted into a hole in the substrate which was previously produced by a drill.

The shaft of the fastening element may define an axis. When the fastening element is introduced into a substrate, this axis can typically be substantially perpendicular to the substrate. This axis may be in the direction of the installation direction. Furthermore, the shaft of the fastening element comprises a projection. The projection is adapted to force the at least two holding elements of the bottom part of the sleeve outwards. This may take place, for example, during the installation of the system when the fastening element is inserted into a substrate.

The substrate may substantially consist of a customary building material. One example is a substrate which is formed from support profiles. For example, L-profiles or T-profiles may be used for this purpose. The support profiles preferably consist of a metal, for example aluminum or steel. However, the substrate may also consist of wood or a wood material. The drilling tip and/or a thread of the fastening element may be specifically configured depending on the material and the nature of the substrate.

The advantage which results from the present invention is that spaced-apart installation of a curtain walling panel on a substrate is made possible. This means that the system is configured to hold the curtain walling panel at a predetermined distance from the substrate without an additional means, such as an intermediate layer, being necessary for this purpose. In other words, a free space is formed between the lower side of the curtain walling panel and the upper side of the substrate during installation. The holding elements can at least partially penetrate into this free space when the projection of the fastening element forces the holding elements outwards during installation. In the arrangements known from the prior art, a soft compressible material is typically used as an intermediate layer between the curtain walling panel and the substrate. A suitable material for this purpose is, for example, cellular rubber, for example EPDM (ethylene-propylene-diene rubber). The soft compressible material may be configured, for example, as an elongate band and be arranged, for example, parallel to the substructure. At present, it is customary to use a band with a width of 10 mm. However, the person skilled in the art is also aware of other ways in which the intermediate layer may be expediently configured. Thus, the material may, for example, also have an annular geometry and be arranged around the hole which is present in the curtain walling panel. The compressibility of the intermediate layer compensates for the production-related thickness tolerance of the curtain walling panels and the swelling and shrinkage behavior under weather influences.

As the person skilled in the art will recognize, the present invention can also be continued to be used with the common form of an intermediate layer. In this case, the intermediate layer is applied to the substrate. In this case, the curtain walling panel can either be fastened so as to bear directly against the intermediate layer or else spaced apart from the intermediate layer. When the curtain walling panel is mounted so as to bear against the intermediate layer, the intermediate layer can be completely or partially compressed by the installation of the curtain walling panel. Furthermore, the present invention allows to abstain from using the intermediate layer. In this case, there is no intermediate layer between curtain walling panel and substrate and the free space between curtain walling panel and substrate remains free or air-filled. A further advantage of the present invention is that the holding elements of the sleeve according to the invention, when inserted into bores of a curtain walling panel, engage behind the curtain walling panel—so-to-speak snap-in—and as a result can be introduced undetachably into bores of the curtain walling panel. This even allows the sleeves to be able to be inserted into correspondingly pre-drilled curtain walling panels already in the factory which provides the curtain walling panels, so that prepared curtain walling panels provided with sleeves for the spaced-apart installation are delivered from the factory, as a result of which complex preparation on the construction site is avoided.

The sleeve may optionally be designed as a so-called sliding point sleeve or as a fixed point sleeve. Both sleeve types allow the spaced-apart installation and achieve the stated object. In addition, the two sleeve types offer specific advantages each.

A sliding point sleeve is distinguished in that a relative movement between the curtain walling panel and the fastening element is made possible after the installation. This can be achieved, for example, in that the curtain walling panel is held on opposite sides between the holding elements of the sleeve and the head of the fastening element and can be displaced therebetween relative to the fastening element.

Deviating from this, a so-called fixed point sleeve is distinguished in that a relative movement between the curtain walling panel and the fastening element is not permitted after the installation. This can be achieved, for example, in that the sleeve enters into a form-fitting connection both with the curtain walling panel and with the fastening element during the installation—for example, in that the sleeve fills an intermediate space between the curtain walling panel and the shaft of the fastening element in a radial plane during the installation. This can be achieved, for example, in that sections of the top part of the sleeve are moved into this free space and towards the shaft of the fastening element. This can be accompanied by a deformation of the top part of the sleeve around the fastening element. In a preferred embodiment, the projection has an annular design and is arranged at the shaft of the fastening element. This has the advantage that an outward forcing of the at least two holding elements is made possible independently of the relative orientation of the fastening element to the holding elements.

The head of the fastening element preferably comprises a tool receptacle. The fastening element preferably comprises a thread. The thread may preferably be located between the end of the shaft which is opposite the head of the fastening element and the projection. If the fastening element has a drilling tip, the thread is thus preferably located between the drilling tip and the projection. Furthermore, the fastening element preferably comprises a thread-free region between the thread and the projection.

In a preferred embodiment, the top part of the sleeve is connected to the bottom part of the sleeve at one or more points via an axial connection. The axial connections are connections which extends substantially parallel to the axis which is formed by the extent of the fastening element. Depending on the type of sleeve, the axial connections may be configured differently. In the case of the sliding point sleeve, it is preferred that the axial connections provide a permanent connection between the top part and the bottom part of the sleeve, while it may be preferred in the case of the fixed point sleeve that the axial connections comprise one or more predetermined separation points. The one or more predetermined separation points can cause the bottom part to be separated from the top part at the respective point under the action of force. In the case of a fixed point sleeve, such separation can lead, for example, to the sleeve being compressed by the installation of the fastening element in the substrate and the sleeve thereby being able to be axially fixed between the head of the fastening element and the substrate.

In certain embodiments of the sleeve, the sleeve may have a centering means. A centering means is preferably configured to improve the relative arrangement between the fastening element and the sleeve at the beginning of an installation. The centering means is preferably configured to make it easier for the user to arrange the fastening element in a predetermined position relative to the sleeve, in particular at the beginning of the installation. A centering means is particularly advantageous in the case of a sliding point sleeve, since it is configured to allow a relative movement of the curtain walling panel and the sleeve arranged therein relative to the fastening element after the installation. Therefore, the sliding point sleeve does not necessarily have a form-fitting connection between the sleeve and the fastening element in the radial direction, as may be the case, for example, in the case of a fixed point sleeve. In the case of a sliding point sleeve, a centering means can therefore make it easier for a user to achieve a desired relative arrangement of the fastening element within the sleeve at the beginning of the installation, in that the centering means predefines the position at which the fastening element should be placed. Even if such a centering means may be advantageous in particular in the case of a sliding point sleeve, a centering means may also be used in the case of a fixed point sleeve in order to improve the initial alignment of the fastening element relative to the sleeve.

The relative arrangement between the fastening element and the sleeve with the centering means may take place, for example, in that the centering means provides a possibility of aligning the fastening element relative to the sleeve. For example, the centering means may be configured to at least partially hold the drilling tip of the fastening element at a predetermined position relative to the sleeve and/or to the bore in the curtain walling panel at least initially during the installation. For example, the centering means may initially hold a drilling tip of a fastening element at the beginning of the installation. In this case, the centering means may predefine a position at which the fastening element penetrates into the substrate during the installation. In one embodiment, the centering means is configured as a ring. In this case, the fastening element may be inserted into the ring and be located with a section—for example, a drilling tip—within this ring at least at the beginning of the installation. The person skilled in the art will understand that such a ring represents one of numerous examples and it is not necessary for the centering means to define a closed surface, as is the case with a ring. The centering means may also be configured as an open ring section—for example, in a U-shape or C-shape.

The centering means may be fastened to the top part of the sleeve or to the bottom part of the sleeve. This fastening may have a predetermined separation point, so that the centering means may be released from the sleeve during the installation by the movement of the fastening element in the direction into the sleeve and the substrate. In this case, the centering means may, for example, fall off the sleeve or be squeezed in between the fastening element, the sleeve and the substrate. The release of the connection between the sleeve and the centering means may take place, for example, by a threaded section, a projection of the fastening element but also by a head of the fastening element. However, the fastening may also be configured without a predetermined separation point. For example, the centering means may also itself be configured in such a way that it no longer restricts a relative movement between the sleeve and the fastening element after the installation.

In one embodiment, the centering means may be fastened to the top part of the sleeve by one or more holding means. The holding means preferably project into the interior of the sleeve. The holding means can extend from any section of the top part of the sleeve into the interior of the sleeve, for example from the collar of the sleeve, from a body of the top part or also from an axial connection of the sleeve. The holding means may extend parallel to the collar or inclined relative to the collar.

In another embodiment, the centering means may be arranged on the bottom part of the sleeve, for example on one of the at least two holding elements. Preferably, the centering means is located in the opening which is formed by the lateral connections. Furthermore, another one of the at least two holding elements may have a recess. This recess may be adapted to receive the centering means. This may be necessary if the at least two holding elements have to be moved towards one another during the installation, for example, in order to insert the sleeve into a bore. In this case, the centering means could oppose such a movement or be damaged during this movement, which is why it may be advantageous if one of the holding elements of the bottom part of the sleeve is provided with a recess which can receive the centering means during a corresponding movement of the holding elements towards one another.

In a preferred embodiment, the top part may comprise a collar. A collar is particularly preferred for a sliding point sleeve and may form a support for the head of the fastening element. As a result, the relative movement between the curtain walling panel and the fastening element may be improved, since the head of the fastening element rests on the collar and may slide over the collar during a relative movement, as a result of which damage to the curtain walling panel by the relative movement is avoided.

In a preferred embodiment, the top part comprises two or more slots which divide the top part into sections. Under the action of force, these sections allow a reduction in diameter of the top part. As a result, it is made possible, for example, for the top part to be able to be pressed into a bore in the curtain walling panel in order to allow a form-fitting connection between the curtain walling panel and the top part of the sleeve. As a result of this reduction in diameter of the top part, it is possible not only to achieve a form-fitting connection between the curtain walling panel and the sleeve, but also to achieve a form-fitting connection between the sleeve and the fastening element in order to allow axial fixing of the sleeve relative to the fastening element, as is intended in the case of a fixed point sleeve.

The object is also achieved by a method for installing curtain walling panels on a substrate. In this case, a sleeve and a fastening element are arranged in a bore in a curtain walling panel. The sleeve and the fastening element may, for example, firstly be arranged one inside the other and then jointly in the bore in the curtain walling panel. However, it is also possible, for example, firstly to arrange the sleeve in the bore in the curtain walling panel and then to arrange the fastening element in the sleeve. The sleeve comprises a top part and a bottom part. The bottom part of the sleeve comprises at least two holding elements which extend at least partially outwards, wherein the holding elements are connected to one another via lateral connections. An opening is formed between the holding elements and the lateral connections. The fastening element comprises a head and a shaft, wherein the shaft of the fastening element comprises a projection. The fastening element is at least partially arranged in the opening during installation.

During the arrangement of the system in the bore in the curtain walling panel, the holding elements of the bottom part of the sleeve are at least partially moved towards one another, i.e., a distance between the holding elements is reduced so that they can be pressed into the bore in the curtain walling panel. This movement may be an elastic process which leads to the holding elements moving apart again when the sleeve is inserted into the bore in the curtain walling panel to such an extent that the holding elements project out of the bore on the rear side.

Within the scope of the method, the fastening element is set into the substrate. This setting may take place into a hole already produced in the substrate or, alternatively, a hole may be produced in the substrate by means of the drilling tip of the fastening element. During the setting, the fastening element is fastened in the substrate. During the setting, the shaft of the fastening element is arranged in the opening in the bottom part of the sleeve.

Furthermore, the method comprises displacing the holding elements of the bottom part of the sleeve into a gap which is formed between the curtain walling panel and the substrate. The displacement is at least partially caused by the projection of the fastening element during the setting of the fastening element into the substrate.

The invention is explained in more detail below on the basis of exemplary embodiments with the attached drawings. Further details, features and advantages of the subject matter of the invention result from the exemplary embodiments described. In the drawings:

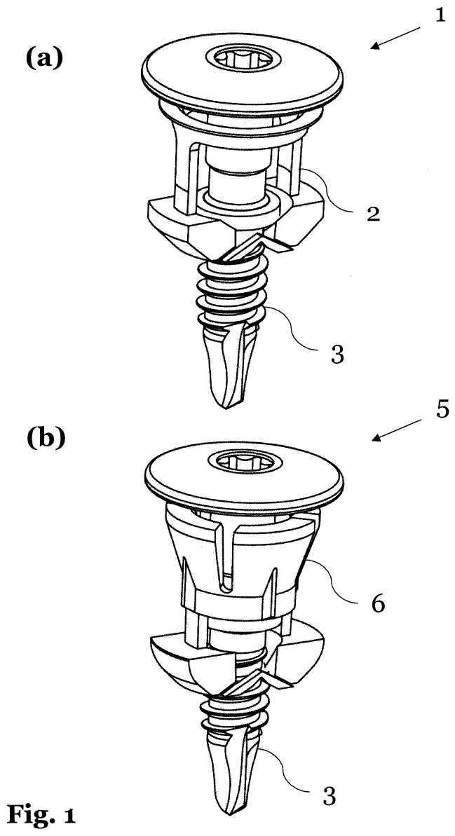

FIG. 1 shows perspective views each of an embodiment of the system according to the present invention for (a) a sliding point sleeve and (b) a fixed point sleeve,

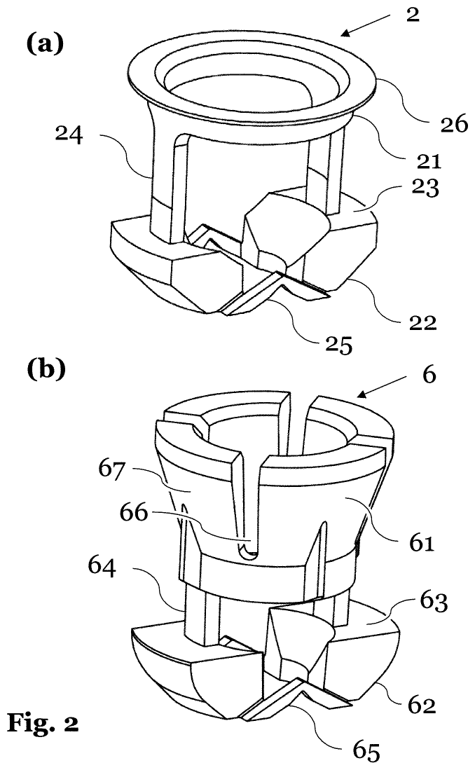

FIG. 2 shows perspective views each of an embodiment of a sleeve for (a) a sliding point sleeve according to FIG. 1 (a) and (b) a fixed point sleeve according to FIG. 1 (b),

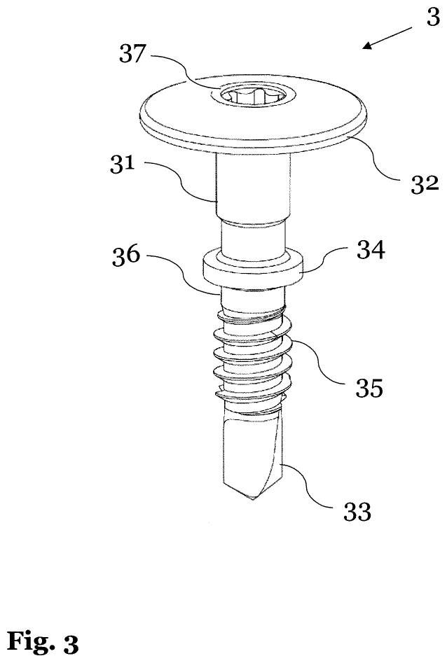

FIG. 3 shows perspective view of an embodiment of a fastening element as shown in FIG. 1,

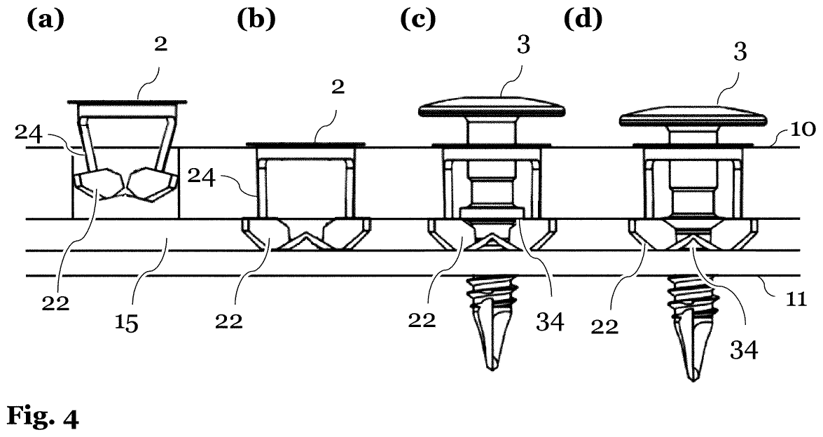

FIG. 4 shows spaced-apart installation of a curtain walling panel with a sliding point sleeve according to FIG. 1 (a),

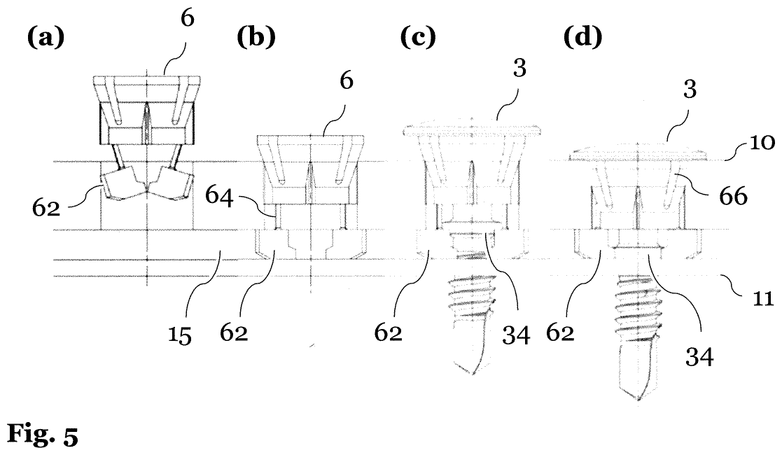

FIG. 5 shows spaced-apart installation of a curtain walling panel with a fixed point sleeve according to FIG. 1 (b),

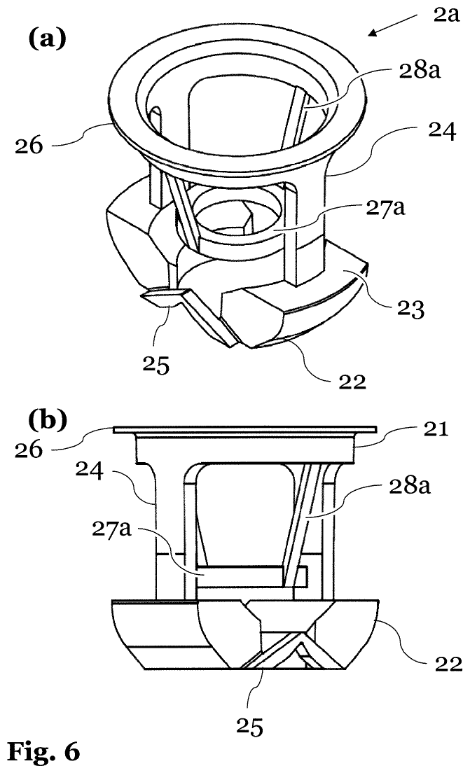

FIG. 6 shows perspective views of a first embodiment of a sliding point sleeve with a centering means, and

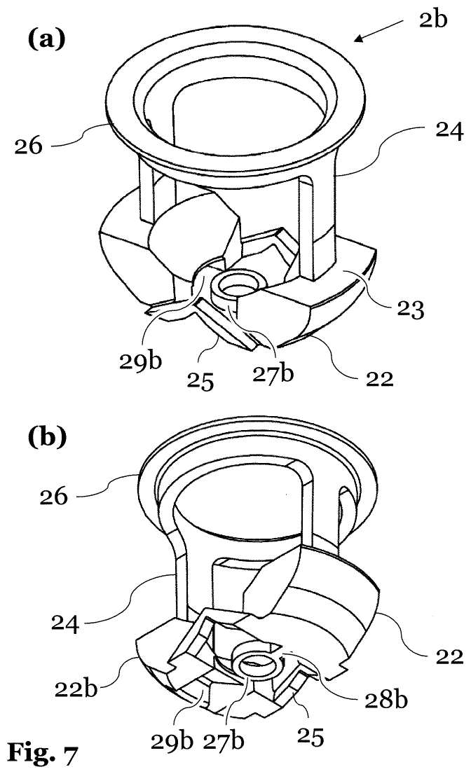

FIG. 7 shows perspective views of a second embodiment of a sliding point sleeve with a centering means.

FIG. 1 (a) shows a perspective view of an embodiment of the system 1 according to the present invention. The system 1 comprises a sleeve 2 and a fastening element 3. The sleeve 2 is configured to be arranged in a predefined position in a bore, for example in a curtain walling panel, and to allow an arrangement of the fastening element 3 relative to the bore, preferably centrally in the bore. The sleeve 2 may be a sliding point sleeve. Similarly, FIG. 1 (b) shows a perspective view of an embodiment of the system 5 of the present invention. The system 5 comprises a sleeve 6 and a fastening element 3. The sleeve 6 may be a fixed point sleeve. The systems 1 and 5 shown in FIG. 1 (a) and (b) show the same fastening element 3. However, the person skilled in the art will understand that different fastening elements can be used as long as they comprise the features according to the invention of a fastening element in the sense of the present application—i.e. a head, a shaft, a drilling tip and a projection.

FIG. 2 shows perspective views each of an embodiment of a sleeve for (a) a sliding point sleeve according to FIG. 1 (a) and (b) a fixed point sleeve according to FIG. 1 (b).

FIG. 2 (a) shows a sleeve 2 designed as a sliding point sleeve. The sleeve 2 comprises a top part 21 and a bottom part. The top part 21 comprises a collar 26 and is connected to the bottom part via two axial connections 24. The bottom part comprises two holding elements 22 which are connected to one another via lateral connections 25. The holding elements extend outwards and form a support 23 on which a curtain walling panel can rest. An opening in which the fastening element 3 can be at least partially arranged during installation is formed between the holding elements 22 and the lateral connections 25.

FIG. 2 (b) shows a sleeve 6 designed as a fixed point sleeve. The sleeve 6 comprises a top part 61 and a bottom part. The top part 61 is connected to the bottom part via two axial connections 64. Furthermore, the top part 61 comprises slots 66 which allow the top part 61 of the sleeve 6 to be compressed in order to allow a firm fit in a bore in a curtain walling panel. The top part 61 is divided by the slots 66 into sections 67 which, when pressed into a bore in the curtain walling panel, reduce their distance from one another and thus reduce the diameter of the top part 61, as a result of which the top part 61 is ultimately compressed. In the compressed state, the sections of the top part 61 can engage around the shaft of the fastening element and fix said shaft.

Furthermore, the bottom part comprises two holding elements 62 which are connected to one another via lateral connections 65. The holding elements 62 extend outwards and form a support 63 on which a curtain walling panel can rest. An opening in which the fastening element 3 can be at least partially arranged during installation is formed between the holding elements 62 and the lateral connections 65.

FIG. 3 is a detailed perspective view of the fastening element 3 already shown in FIG. 1, as can be used within the scope of the present invention. The fastening element 3 comprises a shaft 31 and a head 32. The fastening element 3 preferably comprises a drilling tip 33 which is configured to drill a hole into a substrate. A projection 34 is arranged on the shaft 31 of the fastening element 3.

The embodiment of the fastening element 3 shown in FIG. 3 comprises a thread 35 on the shaft 31 after the drilling tip 33 and a thread-free region 36 is located between the thread 35 and the projection 34.

The head 32 of the fastening element 3 is configured to rest on the collar 26 of the top part 21 of the sleeve 2 in the case of a sliding point sleeve. For this purpose, the head 32 in the exemplary embodiment shown has an outer diameter which is greater than the outer diameter of the collar 26 of the top part 21. The head 32 also comprises a tool receptacle 37. In the case of a fixed point sleeve, the head is configured to rest directly on the curtain walling panel.

The person skilled in the art will recognize that the fastening element shown in FIG. 3 is an example which does not restrict the scope of the present disclosure. In other embodiments which are not shown, the fastening element may have a self-tapping design. In this case, the fastening element does not necessarily have to have a drilling tip, but may be adapted to be inserted into a hole in the substrate which was previously produced by a drill.

FIG. 4 shows the spaced-apart installation of a curtain walling panel with a sliding point sleeve according to FIG. 1 (a).

During the installation, a curtain walling panel 10 is mounted at a distance from a substrate 11. In this case, the distance is measured from the height of the holding elements 22 of the sliding point sleeve.

In a first step shown in FIG. 4 (a), the sliding point sleeve 2 is pressed into a bore in the curtain walling panel 10. For this purpose, the bottom part of the sleeve 2 is compressed by the holding elements 22 of the bottom part of the sleeve 2 being moved towards one another. When the sleeve 2 is inserted deep enough into the bore, the holding elements 22 snap outwards behind the curtain walling panel 10, so that the curtain walling panel 10 rests on the supports of the holding elements 22, as shown in FIG. 4 (b). This is achieved in that the holding elements 22 extend outwards into a free space 15 which is formed between the curtain walling panel 10 and the substrate 11.

In FIG. 4 (c), the fastening element 3 is inserted into the sleeve 2. When the fastening element 3 penetrates further into the substrate 11 during installation, the projection 34 of the fastening element 3 strikes the holding elements 22 and displaces them further outwards, so that the holding elements are fixed in the free space 15 between the curtain walling panel 10 and the substrate 11, as shown in FIG. 4 (d). In this context, this may also be called activation of the holding mechanism of the sleeve.

FIG. 5 shows the spaced-apart installation of a curtain walling panel with a fixed point sleeve according to FIG. 1 (b).

During the installation, a curtain walling panel 10 is mounted at a distance from a substrate 11. In this case, the distance is measured from the height of the holding elements 62 of the fixed point sleeve.

In a first step shown in FIG. 5 (a), the fixed point sleeve 6 is pressed into a bore in the curtain walling panel 10. For this purpose, the diameter of the bottom part of the sleeve 6 is temporarily reduced by the holding elements 62 of the bottom part of the sleeve 6 being moved towards one another. When the sleeve 6 is inserted deep enough into the bore, the holding elements 62 snap outwards behind the curtain walling panel 10, so that the holding elements 62 engage the curtain walling panel 10 on the backside of the curtain walling panel 10. As a result, a support for the curtain walling panel 10 can be formed by the holding elements 62 during installation, as shown in FIG. 5 (b). This is achieved in that the holding elements 62 extend outwards into a free space 15 which is formed between the curtain walling panel 10 and the substrate 11.

In FIG. 5 (c), the fastening element 3 is inserted into the sleeve 6. When the fastening element 3 penetrates further into the substrate 11 during installation, the projection 34 of the fastening element 3 strikes the holding elements 62 and displaces them further outwards, so that the holding elements are fixed in the free space 15 between the curtain walling panel 10 and the substrate 11, as shown in FIG. 5 (d). In this context, this may also be called activation of the holding mechanism of the sleeve.

Furthermore, the advancement of the fastening element 3 into the substrate 11 leads to the top part of the fixed point sleeve 6 being pressed into the bore in the curtain walling panel 10. In this case, there is a reduction in the diameter of the top part of the sleeve 6, since the sections of the top part which are formed by the slots 66 are moved towards one another and thus reduce their relative distances. Since the holding elements 62 cannot move further into the substrate 11 and are fixed between the curtain walling panel 10 and the substrate 11, the top part of the sleeve 6 is moved towards the holding elements 62. In this case, the axial connections 64 which connect the top part of the sleeve 6 to the bottom part are compressed. This preferably results in firm compression of the sleeve components of the fixed point sleeve between the substrate 11 and the head of the fastening element.

FIG. 6 shows perspective views of a first embodiment of a sliding point sleeve with a centering means. This embodiment is based on the sliding point sleeve shown in FIG. 2 (a), for which reason identical features are provided with identical reference symbols. Modified or added features additionally bear the letter “a” in their reference signs. The sliding point sleeve 2a in FIG. 6 has a centering means 27a which is arranged in the interior of the sleeve 2a. The centering means 27a can be used to initially hold a fastening means (not shown) during the installation. As a result, it may be made easier for a user, for example, to align the fastening element relative to the sleeve 2a. For this purpose, for example, a drilling tip of the fastening element (for example, the fastening element from FIG. 3) is inserted into the centering means 27a.

In the embodiment shown, the centering means 27a has the form of a ring, wherein the present disclosure is not restricted to the geometrical form of a ring and other configurations of the centering means can be used as long as they can be used to initially hold the fastening element during the installation. In the case of a ring, a section of the fastening element (for example, the drilling tip 33 of the fastening element in FIG. 3) can be inserted into the ring at the beginning of the installation and held by said ring. In the embodiment shown, the centering means 27a is arranged on the top part 21 of the sleeve 2a by holding means 28a. The holding means 28a project into the interior of the sleeve 2a.

FIG. 7 shows perspective views of a second embodiment of a sliding point sleeve with a centering means. This embodiment is also based on the sliding point sleeve shown in FIG. 2 (a), for which reason identical features are provided with identical reference symbols. Modified or added features additionally bear the letter “b” in their reference signs.

The sliding point sleeve 2b in FIG. 7 has a centering means 27b which is arranged in the interior of the sleeve 2b. Again, the centering means 27b can be used to initially hold a fastening means (not shown) during the installation. As a result, it may be made easier for a user, for example, to align the fastening element relative to the sleeve 2b. For this purpose, for example, a drilling tip of the fastening element (for example, the fastening element from FIG. 3) is inserted into the centering means 27b.

The centering means 27b also has the form of a ring in the embodiment in FIG. 7, wherein the present disclosure is not restricted to the geometrical form of a ring in this case either.

The centering means 27b is arranged with a connection 28b on one of the two holding elements 22 of the bottom part of the sleeve 2b. A recess 29b is arranged on a second holding element 22b which, in the embodiment shown, is opposite the holding element 22 on which the centering means 27b is arranged. If the holding elements 22, 22b are moved towards one another by compressing the lateral connection, as shown, for example, in the illustration of the installation method in FIG. 4 (a), the recess 29b can receive the centering means 27b. As a result, the centering means does not prevent the holding elements from being compressed and is also not damaged by the compression.

During the installation, the centering means 27a, 27b shown in FIGS. 6 and 7 can be squeezed in between the fastening element, the sleeve 2a, 2b and the substrate and thereby be separated from the sleeve 2a, 2b. If a fastening element such as the fastening element 3 from FIG. 3 is used, this may take place, for example, in that the centering means 27a, 27b are squeezed in between the sleeve 2a, 2b, the substrate 11 and the projection 34 and/or the head 32 of the fastening element.

FIGS. 6 and 7 show embodiments of the sliding point sleeve with a centering means for a simplified alignment of the fastening element relative to the sleeve at the beginning of the installation. Even if the appended figures show embodiments of the sliding point sleeve, the person skilled in the art will recognize that the centering means 27a and 27b can also be used in the case of a fixed point sleeve, as shown in FIG. 2 (b), in order to also initially hold a portion of the fastening element during the installation and thereby simplify the relative alignment between the fastening element and sleeve for a user.

1. A system for installing curtain walling panels, comprising:
a sleeve having a top part and a bottom part; and
a fastening element having a head and a shaft,
wherein the bottom part of the sleeve comprises at least two holding elements which extend at least partially outwards, and wherein the holding elements are connected to one another via lateral connections, whereby an opening is formed between the holding elements and the lateral connections, in which opening the shaft of the fastening element is arranged during installation, and
wherein the shaft of the fastening element comprises a projection which forces the holding elements outwards when the fastening element is inserted into a substrate during installation.

2. The system according to claim 1, wherein the projection of the fastening element is annular and is arranged on the shaft of the fastening element.

3. The system according to claim 1, wherein the top part is connected to the bottom part at one or more points via an axial connection.

4. The system according to claim 1 wherein the sleeve comprises a centering means.

5. The system according to claim 4, wherein the centering means is connected to the top part of the sleeve by at least one holding means.

6. The system according to claim 4, wherein the centering means is arranged on one of the at least two holding elements of the bottom part of the sleeve and wherein another of the at least two holding elements comprises a recess which is adapted to receive the centering means when the at least two holding elements of the bottom part of the sleeve are moved towards each other.

7. The system according to claim 1, wherein the top part comprises a collar.

8. The system according to claim 3, wherein the one or more axial connections each comprise a predetermined separation point which, when force is applied, causes the bottom part to be separated from the top part at the respective point.

9. The system according to claim 1, wherein the top part comprises two or more slots which divide the top part into sections and, when force is applied, allow a reduction of the diameter of the top part.

10. A method for installing curtain walling panels, comprising:
arranging a system in a bore of a curtain walling panel, wherein the system comprises:
a sleeve and a fastening element,
wherein the sleeve comprises a top part and a bottom part, wherein the bottom part of the sleeve comprises at least two holding elements which extend at least partially outwards, and wherein the holding elements are connected to one another via lateral connections, whereby an opening is formed between the holding elements and the lateral connections,
wherein the fastening element comprises a head and a shaft, and wherein the shaft of the fastening element comprises a projection, and
wherein the arranging comprises an at least partial indentation of the bottom part, whereby a distance between the holding elements is reduced, so that they can be pressed into the bore in the curtain walling panel;
setting the fastening element into a substrate, wherein the shaft of the fastening element is arranged in the opening in the bottom part of the sleeve; and
displacing the holding elements into a gap which is formed between the curtain walling panel and the substrate, wherein the displacement is caused by the projection of the fastening element during the setting of the fastening element into the substrate.
